(19) United States
(12) Patent Application Publication
(10) Pub. No.: US 2012/0011839 A1
(43) Pub. Date: Jan. 19, 2012

(54) AUXILIARY HYDRAULIC POWER GENERATION SYSTEM

(76) Inventors: Magdy A. Kandil, Rockford, IL (US); David L. Jacques, Caledonia, IL (US)

(21) Appl. No.: 12/834,936

(22) Filed: Jul. 13, 2010

(51) Int. Cl. F16D 31/02; F04B 49/00

(52) U.S. Cl. 60/445; 417/213

(57) ABSTRACT

An auxiliary hydraulic power generation system includes a first spool including a turbine. A fan is coupled to the first spool, the fan operable to drive the first spool in a windmill condition in which the turbine fails to provide rotational drive to the fan. An auxiliary variable displacement hydraulic pump is selectively driven by the first spool in the windmill condition to augment a hydraulic power source.

### BACKGROUND

The present application relates to a gas turbine engine, and more particularly to an auxiliary hydraulic power generation system therefor.

In modern turbofan powered aircraft, an emergency power source is required for control of flight surfaces in the highly unlikely event of a total loss of the availability of the primary power sources; i.e., engine driven hydraulic pumps and/or engine driven electrical generators. For relatively small aircraft, this power is provided by the energy stored in aircraft batteries. For relatively larger aircraft, a ram air turbine (RAT) with an integral generator or auxiliary hydraulic pump is provided for deployment in an emergency situation.

### SUMMARY

An auxiliary hydraulic power generation system according to an exemplary aspect of the present disclosure includes a first spool including a turbine. A fan is coupled to the first spool, the fan operable to drive the first spool in a windmill condition in which the turbine fails to provide rotational drive to the fan. An auxiliary variable displacement hydraulic pump is selectively driven by the first spool in the windmill condition to augment a hydraulic power source.

A method of hydraulic power generation according to an exemplary aspect of the present disclosure includes engaging a coupling to couple a low spool to an auxiliary variable displacement hydraulic pump to permit flow of pressurized fluid from the auxiliary hydraulic pump to an aircraft hydraulic system to augment a hydraulic power source.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic sectional view through a gas turbine engine along the engine longitudinal axis; and

FIG. 2 is a schematic view of a hydraulic power generation system.

### DETAILED DESCRIPTION

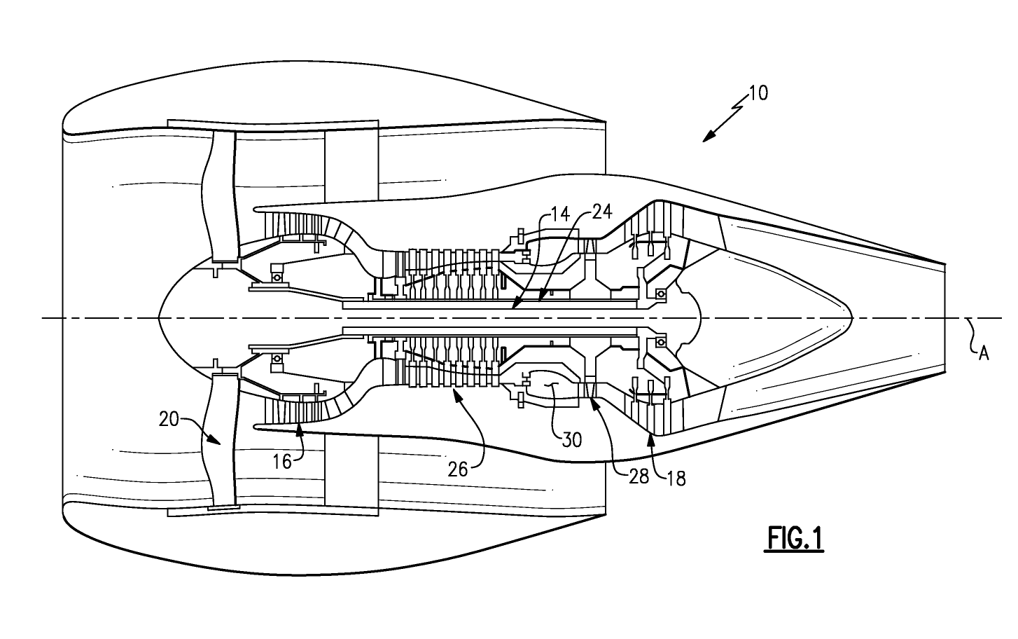

FIG. 1 illustrates a general schematic view of a gas turbine engine 10 such as a gas turbine engine for propulsion. While a two spool high bypass turbofan engine is schematically illustrated in the disclosed non-limiting embodiment, it should be understood that the disclosure is applicable to other gas turbine engine configurations, including, for example, gas turbines for power generation, turbojet engines, low bypass turbofan engines, turboshaft engines, etc.

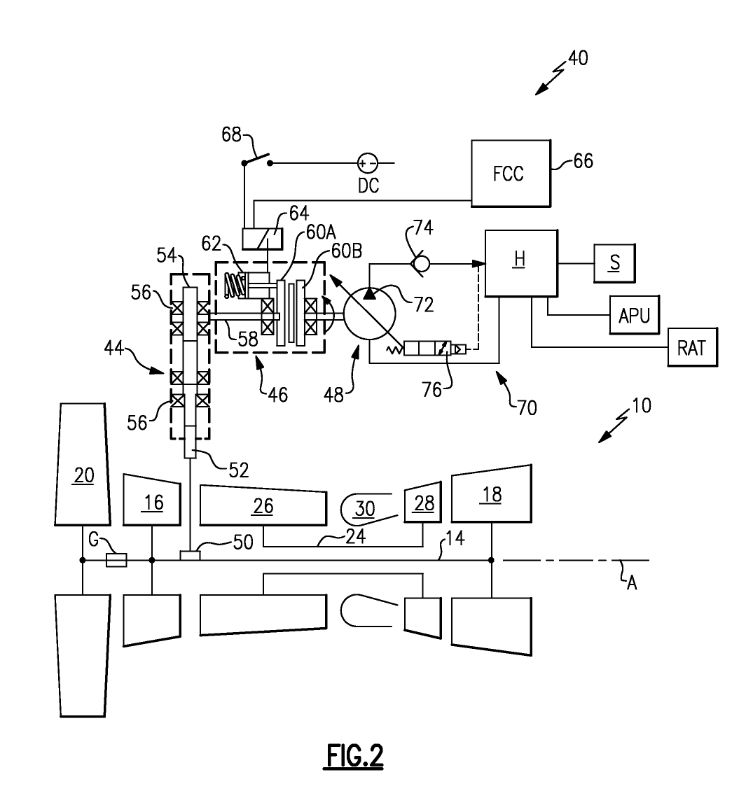

The engine 10 includes a core engine section that houses a low spool 14 and high spool 24. The low spool 14 includes a low pressure compressor 16 and a low pressure turbine 18. A fan 20 is coupled to the low spool 14 either directly or through a geared architecture G (FIG. 2). The high spool 24 includes a high pressure compressor 26 and high pressure turbine 28. A combustor 30 is arranged between the high pressure compressor 26 and high pressure turbine 28. The low and high spools 14, 24 rotate about an engine axis of rotation A.

Air compressed in the compressor 16, 26 is mixed with fuel, burned in the combustor 30, and expanded in turbines 18, 28. The air compressed in the compressors 16, 18 and the fuel mixture expanded in the turbines 18, 28 may be referred to as a hot gas stream along a core gas path. The turbines 18, 28, in response to the expansion, drive the compressors 16, 26 and fan 20 either directly or through a geared architecture.

With reference to FIG. 2, a hydraulic power generation system 40 utilizes the wind-milling condition of the fan 20 to power an aircraft hydraulic system H. The hydraulic power generation system 40 generally includes a speed up gearbox 44, a coupling 46 and an auxiliary hydraulic pump 48. The hydraulic power generation system 40 utilizes the wind-milling condition of the fan 20 which is connected to the low spool 14—typically referred to as an N1 shaft. The system 40 is selectively operable to maintain the desired load pressure for the aircraft hydraulic system H during the windmill condition. The system 40 may also be also used as emergency power to replace or assist a typical Ram Air Turbine (RAT) to reduce weight, size and space required for stowing the RAT.

In a windmill condition, the low spool 14 rotates in response to the fan 20 being driven by airflow but the low pressure turbine section 18 does not provide rotational input. A windmill condition may occur during any number of situations, such as a stall or an ignition or combustion failure in the low pressure turbine section 18.

The speed up gearbox 44 generally includes a low spool gear 50 engaged with a gear shaft 52 which, in turn, is engaged with a pinion 54. The gear shaft 52 and the pinion 54 may be respectively supported by bearings 56 within the speed up gearbox 44. A quill shaft 58 driven by the gearbox 44 connects the pinion 54 to drive the input side of the coupling 46. It should be understood that various gear arrangements may alternatively or additionally be provided.

The coupling 46, such as a centrifugal clutch, is arranged between the speed up gearbox 44 and the auxiliary hydraulic pump 48 to selectively couple the low spool 14 thereto. In one example, the rotational speed of the low spool 14 under normal engine operating conditions may be approximately eight times the windmill condition speed. As a result, it may be desirable for the coupling 46 to decouple the low spool 14 from the auxiliary hydraulic pump 48 above a predetermined rotational speed. As a result, the auxiliary hydraulic pump 48 parameters can be selected to provide desired performance during the lower rotational speeds experienced during the windmill condition.

The coupling 46 may include a set of pressure plates 60A connected to the quill shaft 58, a spring loaded piston 62, and a corresponding set of plates 60B. One side of the spring loaded piston 62 is pressurized via a control valve 64 such as a solenoid operated valve which may be energized by the aircraft flight control computer (FCC) 66 or other control such as a manual pilot-operated switch 68 whenever auxiliary hydraulic power is required. The control operates to depressurize one side of the spring loaded piston 62 to connect the quill shaft 58 to the auxiliary hydraulic pump 48 through the coupling 46.

The coupling 46 is operable to off load the low spool 14 when the hydraulic power demand does not require utilization of the system 40 and disconnect the auxiliary hydraulic pump 48 to maximize operational life as the auxiliary hydraulic pump 48 which is typically maintained in a dormant mode for the majority of its life.

The low spool 14 drives the auxiliary hydraulic pump 48 such as a variable displacement pressure compensated pump through the coupling 46 and the speed up gearbox 44 to operate at speeds higher than the low spool 14 to maximize the volumetric delivery of pressurized fluid. The auxiliary hydraulic pump 48 may be a variable displacement hydraulic pump or include a fluid control circuit 70 (illustrated schematically) which is integrated into or separate from the auxiliary hydraulic pump 48 so as to increase or decrease displacement in response to load flow demand to thereby maintain the desired load pressure for the aircraft hydraulic system H. The fluid control circuit 70 operates to senses the load pressure and adjusts pump displacement to maintain constant pressure regardless of the flow demand from the hydraulic system H.

In one non-limiting embodiment, a discharge port 72 of the auxiliary hydraulic pump 48 is connected to the aircraft hydraulic system H through a check valve 74 to permit flow of pressurized fluid only from the auxiliary hydraulic pump 48 to the hydraulic system H. It should be understood that various flow controls may alternatively or additionally be provided.

In another non-limiting embodiment, the auxiliary hydraulic pump 48 may include an off-loading valve 76 to maintain the auxiliary hydraulic pump 48 at minimum displacement during start up or when the wind-milling condition generated power is insufficient to prevent a stalling condition.

The system 40 thereby uses the wind-milling condition of a non-operating engine to augment other hydraulic power sources (illustrated schematically at S) such as engine driven pumps or electric motor driven pumps so as to, for example: reduce the size and weight of power sources; reduce power extract from the high spool of the operating engine(s) or APU; reduce electric power consumption from operating engine(s) or APU driven generator otherwise required for electric motor driven pumps (EMPs); and reduce weight, size and space required for stowage of other emergency power systems such as a ram air turbine (RAT).

It should be understood that relative positional terms such as “forward,” “aft,” “upper,” “lower,” “above,” “below,” and the like are with reference to the normal operational attitude of the vehicle and should not be considered otherwise limiting.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A hydraulic power generation system comprising:
a first spool including a turbine;
a fan coupled to said first spool, said fan operable to drive said first spool in a windmill condition in which said turbine fails to provide rotational drive to said fan; and
an auxiliary variable displacement hydraulic pump selectively driven by said first spool in said windmill condition to augment a hydraulic power source.

2. The system as recited in claim 1, further comprising a speed up gearbox between said first spool and said auxiliary variable displacement hydraulic pump.

3. The system as recited in claim 2, further comprising a coupling between said speed up gearbox and said auxiliary variable displacement hydraulic pump for selectively driving a generator with said first spool in the windmill condition.

4. The system as recited in claim 1, wherein said first spool is a low pressure spool.

5. The system as recited in claim 4, wherein said coupling includes a clutch.

6. The system as recited in claim 1, wherein a discharge port of said a auxiliary variable displacement hydraulic pump is connected to an aircraft hydraulic system through a check valve to permit flow of pressurized fluid only from said auxiliary variable displacement hydraulic pump to said aircraft hydraulic system.

7. The system as recited in claim 1, further comprising an off-loading valve to maintain said auxiliary variable displacement hydraulic pump at a minimum displacement during start up.

8. The system as recited in claim 1, further comprising an off-loading valve to maintain said auxiliary variable displacement hydraulic pump at a minimum displacement when windmill generated power is insufficient to prevent a stalling condition.

9. The system as recited in claim 1, wherein said hydraulic power source is an engine driven pump.

10. The system as recited in claim 1, wherein said hydraulic power source is an electric motor driven pump.

11. A method of auxiliary hydraulic power generation comprising:
engaging a coupling to couple a low spool to an auxiliary variable displacement hydraulic pump to provide a flow of pressurized fluid between the auxiliary variable displacement hydraulic pump to an aircraft hydraulic system.

12. The method as recited in claim 11, wherein the coupling couples the low spool to the auxiliary variable displacement hydraulic pump in response to the low spool entering a windmill condition.

13. The method as recited in claim 11, wherein the coupling couples the low spool to the auxiliary variable displacement hydraulic pump in response to a manually activated condition.

14. The method as recited in claim 11, further comprising maintaining the auxiliary variable displacement hydraulic pump at a minimum displacement.

15. The method as recited in claim 11, further comprising maintaining the auxiliary variable displacement hydraulic pump at a minimum displacement when windmill generated power is insufficient to prevent a stalling condition to augment a hydraulic power source.
